(19) United States
(12) Patent Application Publication
(10) Pub. No.: US 2002/0019774 A1
(43) Pub. Date: Feb. 14, 2002

(54) Internet advertising

(76) Inventor: Andrew S. Kanter, Califon, NJ (US)

Correspondence Address: Ernest D. Buff, Ernest D. Buff & Associates, LLC, 245 South Street, Morristown, NJ, 07960, US

(21) Appl. No.: 09/909,644

(22) Filed: Jul. 20, 2001

Related U.S. Application Data
(60) Provisional application No. 60/222,618, filed on Aug. 2, 2000.

(51) Int. Cl. G06F 17/60

(52) U.S. Cl. 705/14

(57) ABSTRACT

Advertisements are directed to a user of a web site having at least one page containing a coded reference. When the user accesses the web site, the coded reference directs the browser of the user to a server having an application logic set. Transmission of the advertisement is thereby triggered. The advertisement is displayed in a temporary and non-dismissible window on the user's monitor. Compensation is provided to the user if the user registers for receiving the advertisement. The user may elect to receive a one-time emailing from the advertiser. Ad display is based on the user's system capacity and access speed. Hence, efficiency of ad loading is maximized. Ads open and close automatically, are of short duration, and remain unobtrusive to the user. The temporary nature of the ads captures the attention of the user, giving each message more impact. Viewer ad impressions are accurately tracked. Billing of advertisers is based on actual ad viewing, not estimated user statistics. Demographic information from registered users permits advertisers to custom tailor ad campaigns and product presentations.

### BACKGROUND OF THE INVENTION

1. Field of the Invention

The present invention relates to a system and method of advertising to a user accessing the Internet.

2. Description of the Prior Art

Various advertising systems and methods related to computer use have been disclosed. For example, U.S. Pat. No. 5,781,894 to Petrecca, et al. discloses an advertising system for use with personal computers. The Petrecca, et al. system enables sponsors to present advertisements or commercials to a user during periods of waiting-time which are inherent in normal computer use. Not disclosed therein is an advertising system involving use of the Internet.

U.S. Pat. No. 5,933,811 to Angles, et al. discloses a system and method for delivering customized electronic advertisements in an interactive communication system. Upon receiving an advertising request, an advertising provider computer generates a custom advertisement based on a consumer's profile. The custom advertisement is then combined with an offering from a content provider computer and displayed to the consumer. The advertisement provider computer also credits a consumer account, a content provider account and an Internet provider account each time a consumer views a custom advertisement. Furthermore, the advertisement provider computer tracks consumer responses to the customized advertisements.

U.S. Pat. No. 5,937,392 to Alberts discloses an Internet advertising system having a database, a controller, and an ad server operating as part of a web server. The database has advertising campaign information, including identification information and frequency information for how often the ad is to be served. The ad server uses the campaign information from the database to control the relative ratios of serving ads, the distribution of ads throughout the day, and any triggering mechanisms for controlling which ads are served.

U.S. Pat. No. 5,948,061 to Merriman, et al. discloses methods and apparatuses for targeting the delivery of advertisements over a network such as the Internet. Statistics are compiled on individual users and networks and the use of the advertisements is tracked to permit targeting of the advertisements of individual users.

U.S. Pat. No. 5,999,912 to Wodarz, et al. discloses a dynamic advertising scheduling, display, and tracking for the worldwide web. The Wodarz, et al system includes at least one template web page that has conventional HTML codes defining the format and content of the web page. Special “ad tags” are used to indicate the characteristics of an ad that can be displayed on a web page at the position of the ad tag.

U.S. Pat. No. 6,009,409 to Adler, et al. discloses a system and method for scheduling and controlling delivery of advertising in a communications network and a communications network and remote computer program employing the system or the method.

Numerous non-patent publications disclose web sites utilizing pop-up window advertisements. The user is able to dismiss the ads. An advertisement banner is an integral part of many web pages, and the ad may be different each time the web page is opened. The user is not able to dismiss the banner ad, as it is an integral part of the web page being viewed. In another example, the user can download and install a free toolbar that resides on the user's monitor and delivers personalized news and other information to the desktop. The user receives news, stock prices, and the like on the toolbar in return for receiving an advertisement or series of advertisements. The user can dismiss the toolbar.

In each of the advertising processes noted hereinabove, the advertisement windows are ether dismissible or permanent. What is lacking in previous advertising systems is a non-dismissible, pop-up advertisement window that is presented to the user for a predetermined time, and then disappears. Also lacking is a process that compensates the user for receiving the advertisements. Further lacking is an advertising system in which the complexity of an advertisement is geared to the connection speed of the user.

The conventional Internet advertising model continues to be based primarily on banner advertising. Rates are based on web site traffic or, in the case of click-through banner ads, on the viewer's willingness to leave the site and review the advertiser's content. This form of advertising can detract from the site's content. It is difficult for advertisers to determine ad effectiveness; and the advertising form provides no monetary benefit to the viewer. For click-through banner advertising to be successful, viewers must follow the link to the advertiser's site. Such a process is clearly counterproductive to the content provider's objectives.

Present advertising systems permit neither advertisers nor web site owners to fully capitalize on the growing popularity of the Internet. Banner ad loading can be slow and interferes with the viewing of content. This adversely affects the very audience that advertisers and content providers seek to attract. The keyword selection method of banner advertisements does not provide an attractive mechanism for general brand advertisers to place their messages in front of a demographically qualified audience. In addition, present advertising systems provide no comprehensive means to compensate the advertisement viewer.

The Internet allows a unique interaction amongst the web site owner, the advertiser and the advertisement viewer. Conventional advertising systems have as yet not fully capitalized on the opportunities afforded by this interaction.

### SUMMARY OF THE INVENTION

The present invention provides an advertising system that significantly benefits each of the web site owner, the advertiser and the advertisement viewer. In addition, the system provides a marketing medium that delivers advertisements in a manner which doesn't detract from content, and which is much more receptive to the highly desirable viewer demographic.

Advantageously, the advertisement delivery system provides a reliable outlet for consumer oriented branding campaigns and mainstream advertisers; increased revenue for web site owners; and cash compensation for advertisement viewers. Compensation of ad viewers helps to overcome the public's ambiguous attitude towards advertising. Web site owners are better able to capitalize on the growing viewer market, and advertisers are able to more effectively communicate with consumers.

Generally stated, the present invention provides a system and method for placing an advertisement on a monitor viewed by a user of a web site. The user has an election to register. A user that has registered is compensated for viewing the advertisement. A reference is inserted in the coding on the content provider's web pages. The reference points to application logic that is housed on a remote server. Once the web pages are accessed by a browser, the server delivers a modified web browser window adapted to “pop up” containing an advertisement. The ad size is adjustable, but has default sizes depending on which ad option is utilized. An ad screen opens after a preselected period of time that is adjustable, but will default to 10-15 seconds. Upon conclusion of the preselected time period the window closes. The advertisement is presented in one of three ways, depending on the requirements of the web site owner. The ad is adapted to open: (i) in a window filling the top half of the viewer's monitor screen over the top of the browser (this method has the added benefit that the advertisement opens even with the browser window minimized, offering other marketing options for this technology such as free services paid for by advertiser dollars); (ii) within the browser window; or (iii) in-between pages, while the user moves from one page to the next. By offering different ad location options, the web site owner maintains control over the look and feel of the site. The ad sent is determined by an analysis of the user's system capability. For example, users with high-speed connections and adequate system speed are presented with a full multimedia advertisement while those having slower connections and/or system speeds receive ads that download quickly and run efficiently on their systems. The user has no control over the ad window, i.e. users are unable to minimize, close or move the ad. The user does have an option to register, which is accessed by clicking on the “register now” button. While the ad is open the user may elect to receive additional information in the form of a one-time emailing by clicking on the “more info” button. On sites that retain a user on a particular page for an extended period or time, the system can be adapted to open additional ads at predetermined intervals. This flexibility allows the web site owner to capitalize on the type of site they have and the differences in use from one section of the site to another.

Advertisements are displayed in several ways. Among these are the following display examples: (i) different ads are rotated throughout each time period. That is to say, the first person to access the web site in a particular time period would see ad A, while the second would see ad B and so on; (ii) ads are displayed in a series. A sequential series of ads is adapted to “follow” a user from page to page within a site or amongst many sites. This allows an advertiser to build a brand relationship with the consumer regardless of what page the consumer is viewing; and 3) ad delivery is specific to the demographic information provided by the user. The control over ad delivery allows advertisers to maximize the effectiveness of ad campaigns, thus providing site owners the ability to maximize advertising revenue.

More specifically, the system comprises an Internet server having at least one application logic set stored thereon. Each of the application sets is provided with means for causing a browser to display the advertisement in a non-dismissible and temporary browser window on the user's monitor. The system includes a web site that is provided with coded content for viewing by the user, and a reference coded within at least one page of the web site. The reference points the browser to one of the application logic sets. Additionally, the system includes a registered user database on the server for storing user information and computing and storing the user's advertisement viewing history. When a registered user accesses a page containing the coded reference, the user's browser is caused to access an application logic set on the server thereby triggering display of an advertisement in a temporary and non-dismissible window on the monitor.

Further provided by the invention is a method for advertising to a user of a web site. A user accesses a web site having at least one page provided with a coded reference. The browser is then directed to an application logic set on a server. An application logic set sends an advertisement to be displayed on the user's monitor. The user has an election to register. Next, the advertisement is displayed in a browser window on the monitor of the user. The window is temporarily displayed and it is non-dismissible. Compensation is provided to the user for receiving the advertisement once the user has registered. Advantageously, user access of a page containing the coded reference causes the browser to access the application logic set, in turn, triggering the display of the advertisement in a temporary and non-dismissible window on the monitor.

The invention allows medium and large-scale advertisers to place messages before a large, demographically qualified audience. It provides much needed revenue directly to high and moderate volume web site owners. Like television advertising, the present system utilizes an Internet site as a platform from which to broadcast an advertiser's message. Unlike television, it also provides a means for accurately tracking ad impressions by viewers, and compensates viewers that have registered with the system.

Ads open and close automatically, are of short duration, and remain unobtrusive to the user. User objection and interference with site content are minimized. The temporary nature of the ads captures the attention of the user, giving each message more impact.

Ad display is based on the user's system capacity and access speed. Hence, efficiency of ad loading is maximized. The user cannot control the ad window. Advertisers are thereby assured that ads will be viewed. Once registered, users receive compensation for each ad viewed. In addition, the web site owner is paid on the basis of ads viewed. Billing of advertisers is based on actual ad viewing, not estimated user statistics. Demographic information from registered users permits advertisers to custom tailor ad campaigns and product presentations.

### BRIEF DESCRIPTION OF DRAWINGS

The invention will be more fully understood and further advantages will become apparent when reference is had to the following detailed description and the accompanying drawings, in which:

FIG. 1 is a schematic representation depicting the various elements of the present Internet advertising system;

FIG. 2 is block diagram illustrating the method of the present invention;

FIG. 3 is a schematic representation depicting an alternate embodiment of the method of FIG. 2 integrated with the elements of the system of FIG. 1; and

FIG. 4 is a block diagram depicting optional steps for practicing the method of the invention.

### DESCRIPTION OF THE PREFERRED EMBODIMENTS

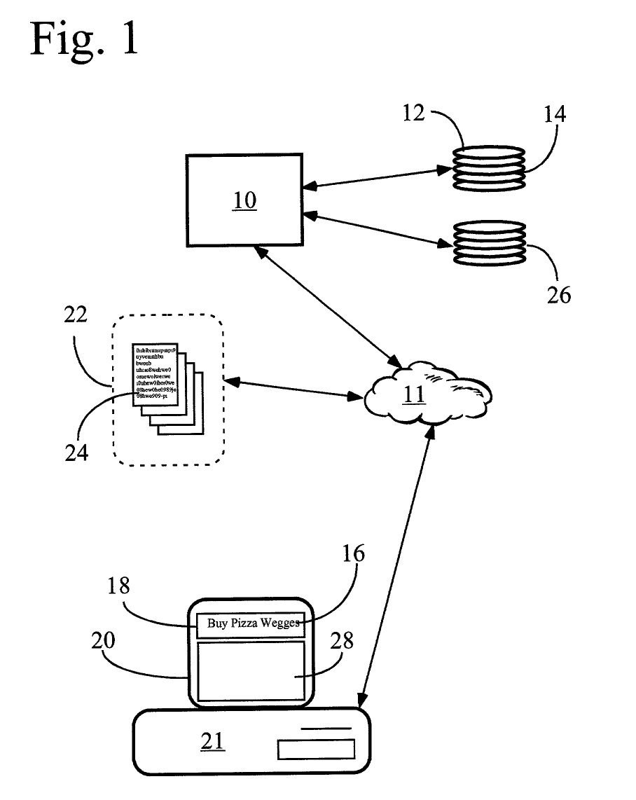

The present invention provides a system and method for placing an advertisement on the monitor of a user of a web site. Specifically, as shown in FIG. 1, the system comprises a server 10 connected to the Internet 11 and at least one application logic set 12 stored in memory 14 on the server 10. As used herein, the term “connected” means a conventional wired connection as would be provided by a modem and telephone line, cable modem, T connection or the like or, alternatively, a wireless connection, such as that provided by a wireless modem, cell phone, PDA or the like. Each of the application logic sets 12 is provided with a means for causing the browser, operating from the user's computer 21, to display the advertisement 16 in a non-dismissible and temporary browser window 18 on the monitor 20 of the user. The means for causing the browser to display advertisement 16 is accomplished by sending web page mark-up language code containing the advertisement 16. This may include HTML, Java Applets, Flash routines, or similar web page construction code. It optionally includes animation, images, and or sound. As a further option the application set 12 includes code for a series of different advertisements. The code specifies the size and position of window 18 as well as how long the window is viewable. The predetermined time period within which the window is viewable can vary depending on default settings, type and length of an advertisement, site owner preference and the like. Typically the predetermined time period for viewing window 18 can range from about 10 seconds to 60 minutes, preferably from about 15 to 40 seconds, and most preferably from about 20 to 30 seconds. Optionally, the advertisement is delayed for period of time before being sent to the user. The system includes a web site 22 that is provided with coded content, such as web page mark-up language, for viewing by the user, and a reference is coded within the mark-up language of at least one page 24 of the web site 22. Web site 22 may reside in memory 14 on server 10 or on another remote server connected to the Internet 11. The reference points the browser to one of the application logic sets 12. Additionally, the system includes a registered user database 26 on the server 10 for storing user information and computing and storing the user's advertisement viewing history. When registered user accesses the page 24 containing the coded reference, the user's browser is caused to access an application logic set 12 on the server 10, thereby triggering display of the advertisement 16 in a temporary and non-dismissible window 18 on the monitor 20 of the user.

Registered user database 26 of server 10 contains demographic information for each user so that advertisements sent to the user are relevant and of interest to the user. A log containing type, number of advertisements and other relevant data is also stored for each user.

As a further option, the application logic set 12 is provided with means for determining the connection speed of the user and selecting an advertisement type that best matches the connection speed, whereby users with high-speed connections will be presented with a full multimedia advertisement while those with slower connections will receive an advertisement that is less multimedia intensive and downloads quickly. The connection speed is herein defined as the combined Internet connection speed as well as the processor speed of the user's computer.

The advertisement window 18 is non-dismissible; that is to say, the user is unable to eliminate the window 18. Preferably, window 18 fills the top half of the user's monitor over the top of the viewed page, as shown in FIG. 1. Alternatively, advertisement 16 is presented within viewed page 28. As a further alternative, advertisement 16 is presented in window 18, in between pages, after moving from viewed page 28 but before a new page is loaded.

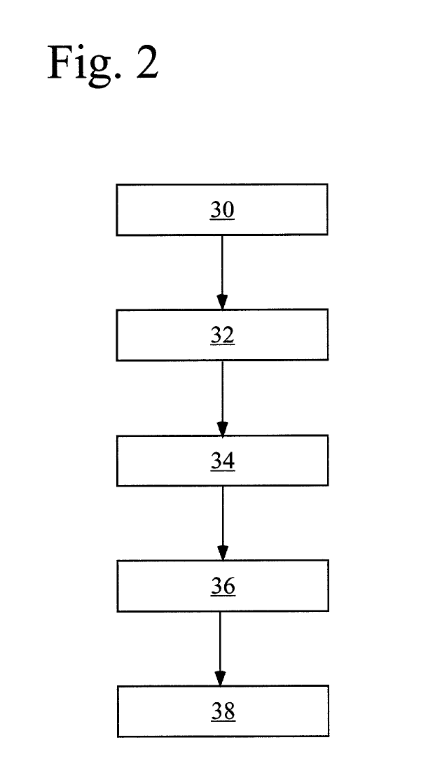

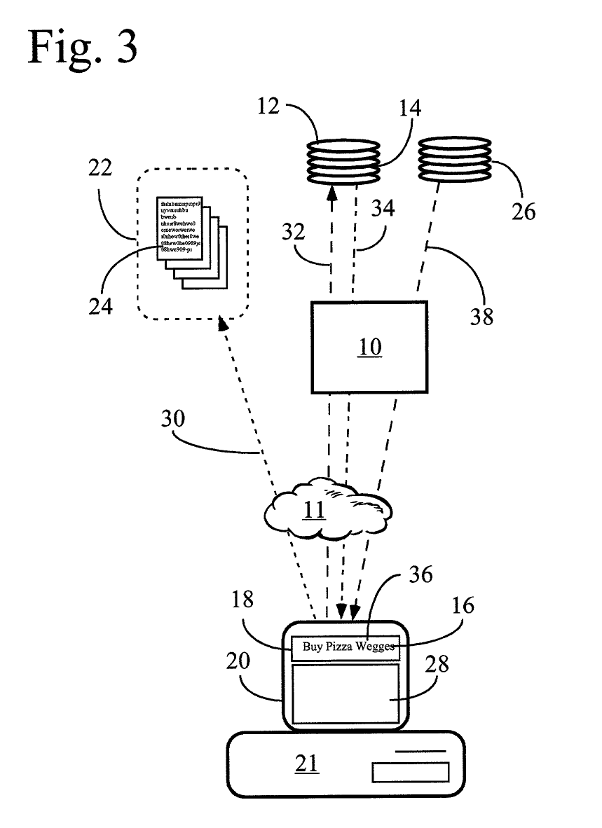

The invention also provides a method of advertising to a registered user as shown in FIGS. 2 and 3. Upon accessing 30 the web site 22 having at least one page 24 provided with a coded reference via Internet 11. The browser of the user is directed 32 to an application logic set 12 connected to server 10, whereupon an advertisement is sent 34 to the user. As a result, the advertisement is displayed 36 in a browser window 18 on the monitor 20 of the user, the window 18 is non-dismissible and viewable for an adjustable predetermined time period, preferably 15-40 seconds. Compensating 38 the registered users for receiving the advertisement is the final step in the procedure. The amount of compensation depends on the total number of advertisements viewed by the user. Compensation takes the form of redeemable coupons, or credits for access time or service deliverable directly to the user's computer. Alternatively, the compensation takes the form of cash rewards.

Preferably, the advertisement sent 34 to the user fills the top half of the monitor over the top of the viewed page 28. Alternately, the advertisement window 18 is presented within the viewed page 28. Further alternatively, the advertisement window 18 is sent 34 after the user moves from the viewed page 28; but before a new page loads. As a further alternative, a series of advertisements are sent 34 to the user. Optionally, displaying the advertisement is delayed for an adjustable predetermined time.

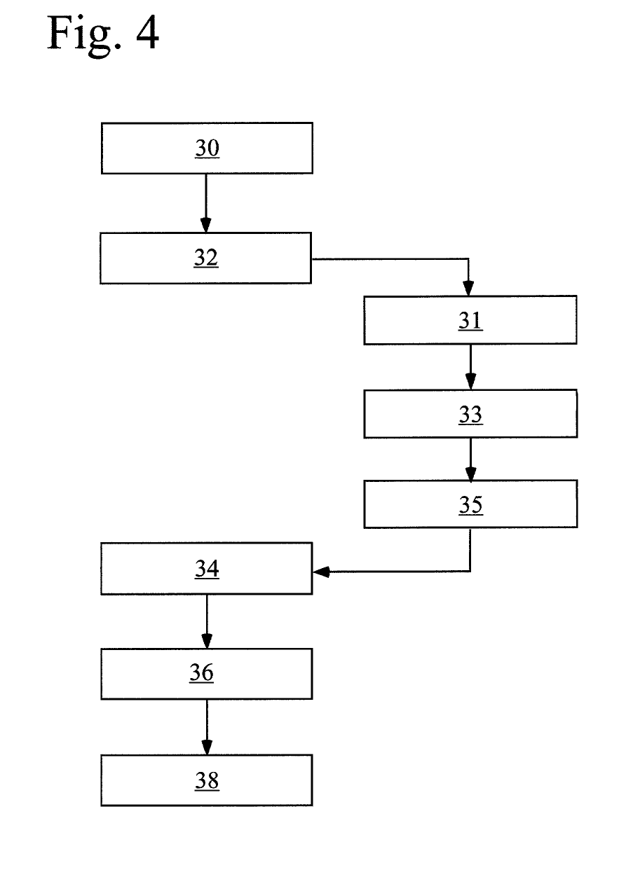

As shown by FIG. 4, the additional steps of determining 31 the connection speed of the user and selecting 33 an advertisement type appropriate for the connection speed can optionally be added to the above-described method. The connection speed is defined herein as the combined Internet connection speed as well as the processor speed of the user's computer. As a further option, the advertisement is matched 35 to the profile stored in the registered user database 26.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A system, for placing a advertisement on the monitor of a user of a web site, comprising:
a) an Internet server;
b) at least one application logic set stored on said server, each application logic set being provided with means for causing the browser to display said advertisement in a non-dismissible and temporary browser window on said monitor;
c) a web site provided with coded content for viewing by said user;
d) a reference coded within at least one page of said web site, said reference pointing to said application logic set, and
e) a registered user database on said database for storing user information and computing and storing the user's advertisement viewing history,
whereby upon access by said user of said page containing said coded reference, the reference is caused to access its application logic set triggering display of said advertisement in a temporary and non-dismissible window on said monitor.

2. A system as recited by claim 1 wherein said application logic set further provided comprises means for determining the connection speed of said user and selecting an advertisement type that best matches said connection speed, whereby users having high-speed connections are presented with a full multimedia advertisement while users having slower connections receive an advertisement that is less multimedia intensive and downloads quickly.

3. A system as recited by claim 1 wherein said user's monitor has a top half and said page has a top, and said advertisement is presented in a browser window filling the top half of the user's monitor over the top of said page.

4. A system as recited by claim 1 wherein said advertisement is presented within the browser window displaying said page.

5. A system as recited by claim 1 wherein said advertisement is presented in a browser window after moving from said page but before a new page is loaded.

6. A system as recited by claim 1 wherein said at least one application logic set further comprises means for causing said browser to display a series of advertisements in a non-dismissible and temporary browser window on said monitor.

7. A system as recited by claim 1 wherein said at least one application logic set further comprises means for delaying the display of said advertisement for a predetermined time period.

8. A system as recited by claim 1 wherein said web site has at least one page comprising a register button, said button being adapted to be placed in an on condition, causing a registration window for receiving user's demographic information.

9. A system as recited by claim 1, wherein said web site has at least one page comprising a more information button adapted to be placed in an on condition for causing a one time emailing of additional information about the advertisement to the user, said information optionally comprising additional links to a website for a company sponsoring the advertisment, to provide for purchase of coupons and other purchase incentives.

10. A method for advertising to a user of a web site having at least one page containing a coded reference, comprising the steps of:
a. accessing said web site;
b. directing the browser of said user to a server having an application logic set;
c. sending an advertisement to said user;
d. displaying said advertisement in a browser window on the monitor of said user, said window being non-dismissible and temporary; and
e. compensating said user for receiving said advertisement provided said user has previously registered,
whereby upon access by said user of said page containing said coded reference, said reference causes said browser to access said application logic set thereby triggering display of said advertisement in a temporary and non-dismissible window on said monitor.

11. A method as recited by claim 10, further comprising the step of delaying said display of said advertisement for a predetermined period of time.

12. A method as recited by claim 10, wherein said advertisement comprises a series of advertisements.

13. A method as recited by claim 10, wherein said monitor has a top half and said page has a top, and step “d” further comprises displaying said advertisement in a browser window that fills the top half of said monitor over the top of said page.

14. A method as recited by claim 10, wherein the step of displaying said advertisement window occurs within the page being viewed.

15. A method as recited by claim 10, wherein the step of displaying said advertisement window occurs after the user moves from said page, but before a new page is loaded.

16. A method as recited by claim 10, wherein the step of displaying said advertisement window is delayed for a predetermined time.

17. A method as recited by claim 10, wherein steps “c” “d” and “e” are replaced by steps “C”, “D”, “E”, and “F”, which comprise:
C) matching an advertisement to a profile stored in the registered user data base;
D) sending said matched advertisement to said user;
E) displaying said matched advertisement in a browser window on the monitor of said user, said window being non-dismissible and temporary; and
F) compensating said user if said user has registered with said web site for receiving said advertisement.

18. A method as recited by claim 10, wherein steps “c”, “d” and “e” are replaced by steps “C”, “D”, “E”, “F” and “G”, which comprise:
C) determining the connection speed of said user;
D) selecting an advertisement type appropriate for said connection speed;
E) sending said selected advertisement to said user;
F) displaying said advertisement in a browser window on the monitor of said user, said window being non-dismissible and temporary; and
G) compensating said user provided that said user has registered with said web site for receiving said advertisement.

19. A method as recited by claim 17, wherein steps “c” and “d” are replaced by steps “C” and “D”, which comprise:
C) determining the connection speed and computer type of said user; and
D) selecting an advertisement type appropriate for said connection speed and said computer type.

20. A method as recited by claim 2, wherein said connection is wireless.
